(19) United States
(12) Patent Application Publication
(10) Pub. No.: US 2026/0186838 A1
(43) Pub. Date: Jul. 2, 2026

(54) TASK-BASED OFFLOAD PROCESSING

(71) Applicant: Microsoft Technology Licensing, LLC, Redmond, WA (US)

(72) Inventors: Edward GAMSARAGAN, Kirkland, WA (US); Paul ZAGACKI, Lake Oswego, OR (US)

(73) Assignee: Microsoft Technology Licensing, LLC, Redmond, WA (US)

(21) Appl. No.: 19/008,411

(22) Filed: Jan. 2, 2025

(51) Int. Cl. G06F 9/50

(52) U.S. Cl. CPC G06F 9/5027; G06F 2209/509

(57) ABSTRACT

Aspects of the present disclosure relate to improving processing efficiency of compute resources. In examples, a client device includes an application having a plurality of tasks to be performed. A processor of the client device performs the tasks, and a resource manager evaluates performance characteristics of the processor for efficiency. In the event that the resource manager identifies a processing inefficiency, the resource manager selects specific tasks to offload to an alternate computing system for processing.

### BACKGROUND

Client devices, such as notebook computers, smartphones, etc., are continuously challenged to do more with a limited set of resources, which ultimately impacts their performance. Some client devices include system-on-a-chip (SoC) technology, in which a single microchip can include a plurality of components, such as a central processing unit (CPU), graphics processing unit (GPU), memory, modem, and input/output devices and interfaces. However, SoCs continue to increase in complexity and capability at an ever-growing rate each year. SoCs are integrating additional subsystems such as image signal processors for cameras, dedicated audio engines, and neural network processors. These designs can require significantly increased on-die memory, while also being challenged with maintaining low power demand, small size, and low production cost. Such design constraints and heavy computational workloads can negatively affect local compute performance by client devices.

It is with respect to these and other general considerations that embodiments are described below. Also, although relatively specific problems have been discussed, it should be understood that the embodiments should not be limited to solving the specific problems identified in the background.

### SUMMARY

Aspects of the present disclosure relate to improving processing efficiency of client computing systems by offloading certain tasks to alternate computing resources for processing, such as a cloud-based service or another remote computer server. Offloading some of the tasks improves the performance of the remaining tasks to be completed by the client machine. In examples, the client device is executing one or more applications, each having a plurality of tasks to be completed. Some of the various tasks can be separated from others and processed by another computing system, as opposed to offloading the one or more full applications to the other computing system. In embodiments described herein, a resource manager evaluates performance characteristics of the client device for performance and efficiency and, when the resource manager identifies, during execution, a processing inefficiency or other performance issues, the resource manager selects one or more tasks of at least one application to offload to the other computing system. To select the one or more tasks, the resource manager evaluates the resource consumption of the tasks to determine which tasks to offload.

With respect to other aspects, the resource manager evaluates the performance of specific tasks during runtime to create or update load information related to the task that may be stored for future use. Consequently, when processing the task in the future, the resource manager may use that stored task-based load information to determine whether the task should be offloaded, as discussed below.

This summary is provided to introduce a selection of concepts in a simplified form that are further described below in the Detailed Description. This summary is not intended to identify key features or essential features of the claimed subject matter, nor is it intended to be used to limit the scope of the claimed subject matter.

### BRIEF DESCRIPTION OF THE DRAWINGS

FIG. 1 depicts an example computing environment having a resource manager, in accordance with embodiments of the present disclosure.

FIG. 2 depicts a flowchart of an example method for managing compute resources, in accordance with embodiments of the present disclosure.

FIG. 3 depicts a flowchart of an example method for evaluating and storing load information for an application, in accordance with embodiments of the present disclosure.

FIG. 4A illustrates an example use of a resource manager, in accordance with embodiments of the present disclosure.

FIG. 4B illustrates an example use of a resource manager, in accordance with embodiments of the present disclosure.

FIG. 5 depicts a flowchart of an example method for managing compute resources, in accordance with embodiments of the present disclosure.

FIG. 6 illustrates a block diagram illustrating example physical components of a computing device with which aspects of the disclosure may be practiced.

FIG. 7 is a simplified block diagram of a mobile computing device with which aspects of the present disclosure may be practiced.

### DETAILED DESCRIPTION

The present disclosure relates to managing client compute resources. More particular aspects relate to selectively utilizing cloud and client compute resources for efficient computing. Other particular aspects relate to offloading specific tasks of an application to a cloud environment for processing to improve performance and efficiency. Such an evaluation is based on an analysis of the performance characteristics of the processor and the related running tasks and/or to-be-executed tasks. When the client computing device is experiencing performance or efficiency issues, embodiments described herein selectively identify and transfer specific tasks to the cloud-based service for processing.

As noted above, client devices, such as notebook computers and smartphones, are continuously challenged to do more with limited local compute resources, which can adversely affect performance. Previous approaches to addressing such limitations permitted a user of a client device to manually select a cloud computing environment, rather than a local computing environment of the client device, to execute, for example, an entire desktop of the client device. Such a previous selection processes are not transparent to the user and do not account for specific tasks of an application that may be better performed by the client device, e.g., tasks relating to UI or other latency sensitive tasks.

To address these and other challenges, embodiments of the present disclosure include a client device resource manager configured to dynamically offload tasks from a client device to an alternate device, which may be a cloud-computing resource or service based on one or more criteria. Since the resource manager does not need to be a separate component, embodiments may include modifications to existing schedulers such that tasks may be dynamically offloaded, as discussed below. The dynamic offloading is designed to be transparent to the user, and is done, in embodiments, at the task level. That is, an executing application performs many tasks, and embodiments of the present technology may offload one or more of the the many tasks to the cloud-computing resource while performing the remaining tasks on the local client device. Upon completion of the offloaded task(s), the cloud computing resource returns the result(s) back to the client device for substantially seamless application execution, as perceived by the user.

In embodiments, task-based load information or a “hint” (e.g., information characterizing a compute demand of a task and/or information related to a preference to preform locally instead of remotely) can be stored to indicate whether a particular task may or should be offloaded to a cloud-computing resource. By selectively offloading tasks to an alternate device based on task-based load information, embodiments of the present disclosure can distribute individual computing tasks for improved computing efficiency. Additionally, embodiments of the present disclosure may involve tailoring the selective offloading of tasks according to the task to be performed and the available capacity of client computing resources. By automatically offloading selected tasks to an alternate device, embodiments of the present disclosure can provide efficient computing in a manner that does not require user input; thus, the management of computing resources can be effectively transparent to an end-user.

In certain embodiments, applications that tend to always perform compute-intensive operations, such as photo editing, video editing or gaming, may be resolved to regularly offload specific tasks to run on the remote device or server, when such server is available. In such examples, the compute-intensive tasks may run on the server, whereas the rest of the application may run locally. Further, the local window manager will composite received remote content with the local content on the client’s display. In this example, the specific task executes entirely on the server, captures the rendered result, and may encode it in a video compression format and continually streams its rendered result to the client device. The client device decodes and displays this content in a manner similar to the decoding and display of other streaming media content.

In other embodiments, applications which sometimes perform compute-intensive tasks (e.g., re-paging documents, encoding a file, batch filtering and/or spreadsheet calculations) may have those specific tasks dynamically offloaded to be performed remotely on a cloud server while other, e.g., user-interactive tasks (e.g., audio, screen interaction, mouse clicks) may be performed locally on the user device. Accordingly, embodiments of the present disclosure can manage/maintain a preferred degree of responsiveness of an application. For example, in circumstances when responsiveness and/or processing performance and/or efficiency would be degraded by performing both compute-intensive tasks and user-interactive tasks locally, embodiments of the present disclosure can reduce such degradation by offloading selected tasks.

With respect to other aspects, the described technology relates to the dynamic profiling of substantially every task. Such profiling may relate to a combination of performance counters and or other processor state information associated with the different tasks. In essence, the operating system of the client device, in some embodiments, assigns a budget to each thread, and this can be used as a threshold to determine the impact of executing the task (or not) on the local device, as discussed in more detail below.

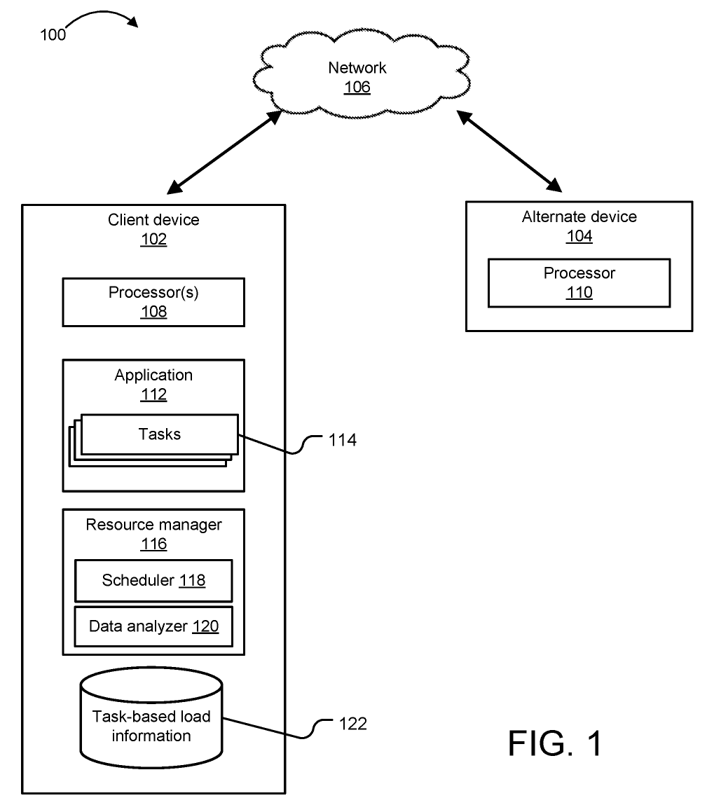

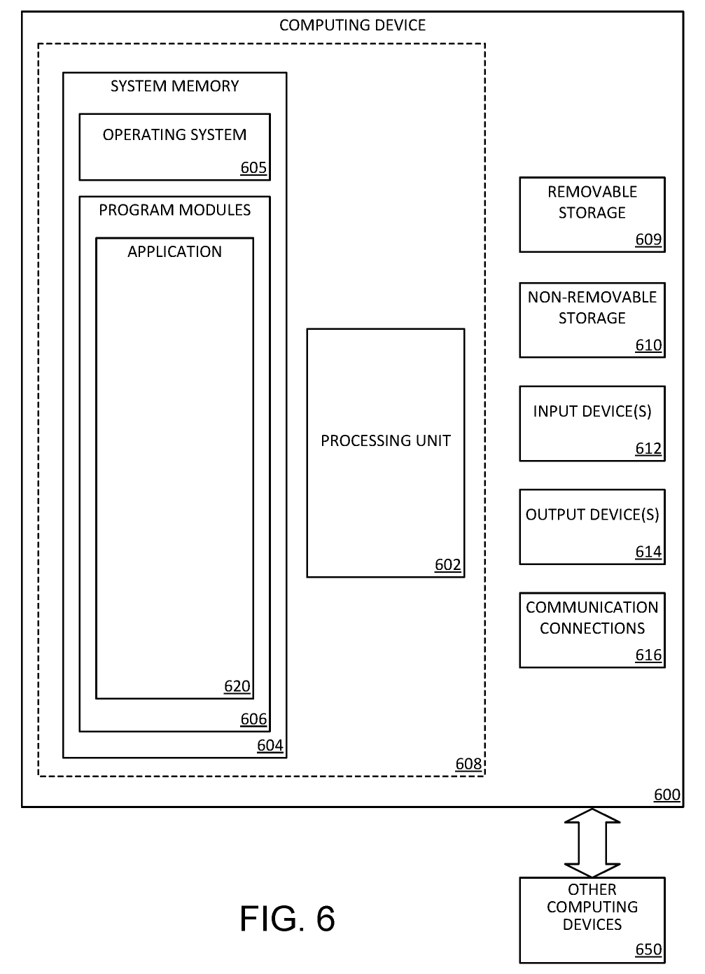

FIG. 1 shows an example computing environment 100 having a client device 102 (e.g., a smartphone, tablet, notebook computer, and the like) in communication with an alternate device 104 (e.g., a cloud-bases service, a remote server or another computing device other than client device 102) over a network 106 wherein the client device 102 offloads one more tasks to the alternate device 104 to improve efficiency and/or performance. As will be appreciated by one skilled in the art, each of the client device 102 and alternate device 104 may comprise an exemplary computing device (e.g., illustrative computing device 600, discussed in more detail below in conjunction with FIG. 6). Also, as may be appreciated, network 106 represents an exemplary communication network such as a wide area network (WAN), a local area network (LAN), the internet, or an intranet, or the like.

According to embodiments of the present disclosure, client device 102 has one or more processors 108 used to execute one or more applications, such as application 112. Execution of the application 112, in turn, involves the execution of a plurality of tasks 114. During execution of the application 112, the processor(s) may experience performance or efficiency issues such that one or more of the tasks 114 are then offloaded to the alternate device 104 to be executed by a processor 110 associated with the alternate device 104.

To accomplish such offloading, the client device 102 may use a resource manager 116 to evaluate performance and cause the offloading of the one or more tasks 114. The resource manager 116, in embodiments, uses a scheduler 118 to schedule tasks to be performed locally or to be performed on the alternate device 104. In embodiments, the resource manager 116 uses a data analyzer 120 to evaluate processor performance during the execution of applications to determine whether offloading should occur. As stated, if the resource manager 116 determines that processor 108 is not performing tasks 114 efficiently, then the resource manager evaluates the executing tasks 114 and determines which tasks to offload to the alternate device 104 via network 106.

In an embodiment, the resource manager 116 may use task-based load information 122 to help identify which tasks to offload. Task-based load information 122 includes information suggesting whether one or more respective tasks may be more efficiently performed by processor 110 of alternate device 104, rather than by processor 108 of client device 104. In embodiments, such task-based load information 122 is relatively static and is either saved information based on previous execution events related to the task and/or information provided by a developer of the application itself. In such embodiments, such task-based load information 122, may be used by the resource manager 116 to help select one or more target tasks among the tasks 114 for offloading/transferring to processor 110 of alternate device 104. Upon selection, the resource manager 116, using scheduler 118, causes the offloading of such target tasks so that the target tasks can be performed by processor 110.

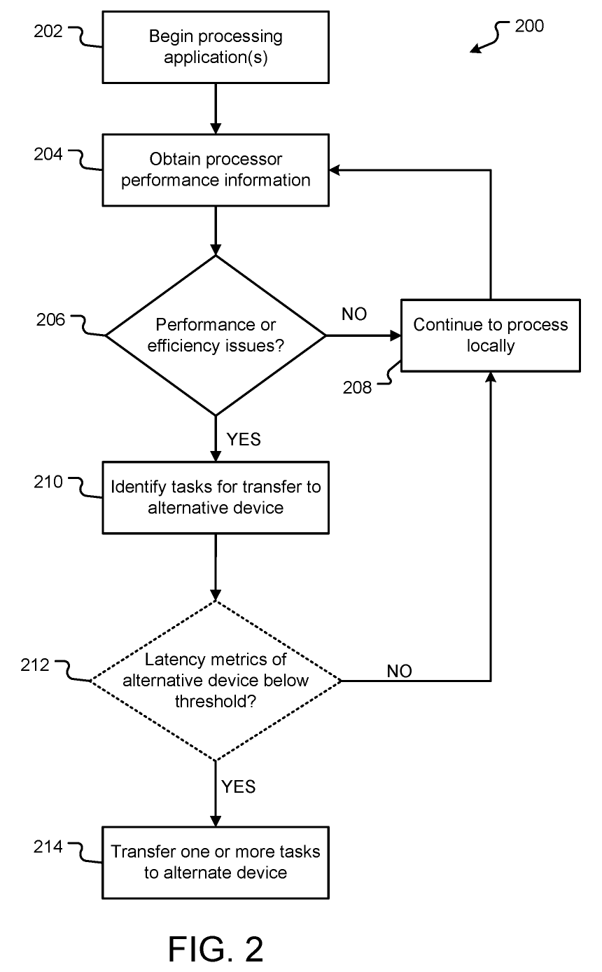

As will be appreciated by those skilled in the art, resource manager 116 performs one or more operations discussed below with respect to FIGS. 2-5. In some embodiments, resource manager 116 can include one or more modules, such as scheduler 118 and data analyzer 120, or, in other embodiments may use more modules in analysis and completion of the offloading of specific tasks. In other embodiments, resource manager 116 can also obtain, generate, output, and/or store data (e.g., application data, task-based load information, offload instructions, among others). As described herein, data analyzer 120 can analyze (e.g., compare, rank, and/or interpret) data.

FIG. 2 illustrates a flowchart of an example method 200 for managing compute resources in accordance with embodiments of the present disclosure. In embodiments, method 200 can be performed, in part, by a resource manager (e.g., resource manager 116, FIG. 1). To begin, the method 200 start processing one or more applications, as shown in operation 202. One skilled in the art will appreciate that operation 202 relates to the launching of one or more applications within the local device, such as client device 102 (FIG. 1).

Next, obtain operation 204 obtains (e.g., receives or retrieves) processor performance information. Processor performance information can include information associated with a processor’s availability, compute/processing capacity, and/or processing performance associated with performing one or more tasks. In some instances, processor performance information can include a value indicating a percentage utilization of a processor associated with the processor performing a task. In some cases, processor performance information can include information such as a time duration or frequency associated with a processor performing a task. In embodiments, the resource manager obtains processor data from a local processor of the client device, a remote processor of a server, and/or a set of performance counters associated with a local or remote processor. Obtaining processor data allows the resource manager to determine whether a task may be more efficiently performed by a remote processor as compared to the local processor or otherwise manage task allocation to improve performance and efficiency.

Next, evaluate operation 206, evaluates the processor data, as well as any other task-based information, e.g., potential upcoming bottle-necks, and determines whether there are performance and/or efficiency issues, either presently or potentially in the near future. If there are no performance or efficiency issues, then flow branches NO to operation 208 which continues to process the tasks locally. Flow may then cycle back to obtain operation 204 to continue to monitor the performance of the local processor(s). Those skilled in the art will appreciate that while the phrase “issue” is used herein, other embodiments may evaluate for performance and/or efficiency “opportunities” wherein the system may offload tasks to correct issues and/or improve performance.

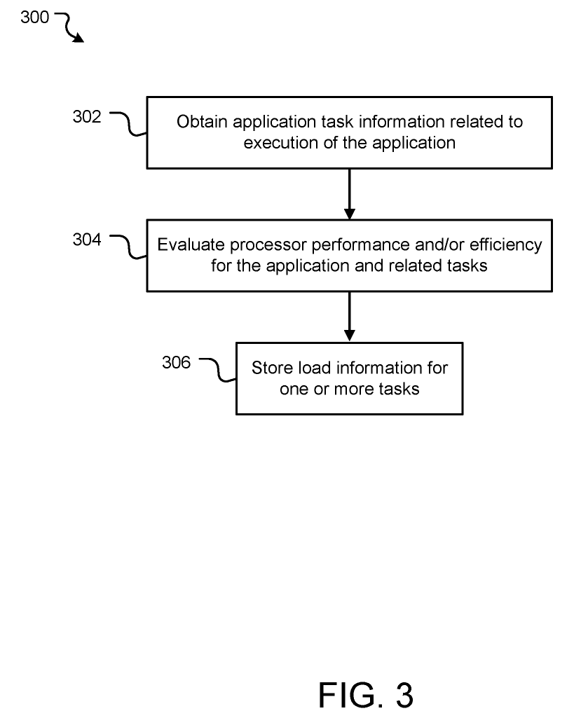

If, however, there are some performance or efficiency issues as determined by operation 206, then flow branches YES to identify operation 210. Identify operation 210 identifies one more tasks that may be transferred to an alternate device. In some instances, criteria for identifying tasks for potential offloading/transferring relates to whether such tasks are available for such a transfer. That is, some tasks may be designed to operate locally in all circumstances such that the tasks will not be offloaded. While other cases relate to tasks that may be predetermined to be compute-heavy tasks and may be quickly identified for transfer when appropriate. Such compute-heavy tasks can be transferred to an alternate device to be performed/processed. In some embodiments, the determination by the resource manager whether one or more tasks are available for transfer can be included in a task-based load information that may be stored in a storage location, as discussed with respect to FIG. 3.

In some instances, determining there are performance or efficiency issues may include analyzing thresholds associated with the local processor (e.g., the local processor of the client device performing a task). Such thresholds can be associated with parameters such as a processing time, processor voltage and/or frequency, processor capacity, and the like. In such instances, the resource manager may determine that a task is a compute-heavy task in response to determining that a threshold is exceeded when a processor performs the task. For example, a set of thresholds can include a 60% utilization threshold (e.g., a maximum value for local processor utilization while the local processor performs a task). In this example, a local processor that exceeds the threshold can be deemed as processing a compute-heavy task. Continuing with this example, in response to receiving processor data indicating that a local processor is 70% utilized while performing a task, the resource manager can proceed to operation 210 to identify the task for transfer to an alternate device to be performed/processed.

In some instances, identifying whether one or more tasks should be transferred to an alternate device can include determining whether a task is a user-interactive or other latency-sensitive task (e.g., a task associated with audio and visual aspects of a graphical user interface, such as user-selections by a mouse). Such tasks should likely be processed by a local processor to achieve a preferred end-user experience. In certain cases, an application may indicate a list of user-interactive task identifiers corresponding to user-interactive tasks for that application. In such instances, in response the resource manager obtains such task identifiers to aid in deciding to process the one or more tasks locally at operation 208, as discussed below in more detail.

Following identify operation 210, some embodiments may include an evaluate operation 212, wherein the method may evaluate metrics related to the remote processor to determine if a transfer of one more tasks is desirable. In essence, understanding the relatively current state of the remote processor to which tasks may be transferred may help determine if the remote processor may be overburdened and/or will take too long to process a given task resulting in excessive latency. Certain latency thresholds may be provided by and/or associated with the application to enable a comparison at operation 212. Consequently, evaluate operation 212 may be thought of as a feedback loop in that the method may communicate with the remote processor and get feedback as to the current state of the remote processor. Evaluate operation 212 is shown with a dotted line in FIG. 2 as it may be considered an optional step employed in some embodiments. If the remote processor is overburdened and/or transferring the identified task would exceed predetermined threshold values, then flow branches NO to operation 208 to continue to process the task locally. Otherwise, flow branches YES to transfer operation 214.

Next, in operation 214, the resource manager initiates a transfer of the task to a remote processor of a remote server. For example, in operation 214, the resource manager can generate an offload instruction to be transmitted to a scheduler of an operating system of the client device. The offload instruction can include an instruction to transfer the task and data for performing the task to the remote processor.

FIG. 3 shows a flowchart of an example method 300 for generating task-based load information, such as task-based load information 122 shown in FIG. 1, in accordance with embodiments of the present disclosure. First, obtain operation 302, the resource manager obtains application information related to the execution of the application and/or a specific task itself. Such information may relate to historical task performance and/or efficiency values. In embodiments, such application or task information may necessarily come from the application or process itself.

Next, in operation 304, the resource manager evaluates processor performance and/or efficiency during the execution of the task. During this process step, many variables may be evaluated, such as user interaction, batch processing, memory usage, etc. In some situations, it may be determined that a particular task should preferably be performed locally. In other situations, other tasks may be determined to be good candidates for offloading should the need arise. For example, evaluation of one more tasks may indicate that the local processor exceeded a utilization threshold while performing the task. Consequently, evaluate operation 304 may generate task-based load information indicating that a specified task of a specified application is a “compute-heavy task” (e.g., ultimately, a task that would be better performed by a remote processor when available).

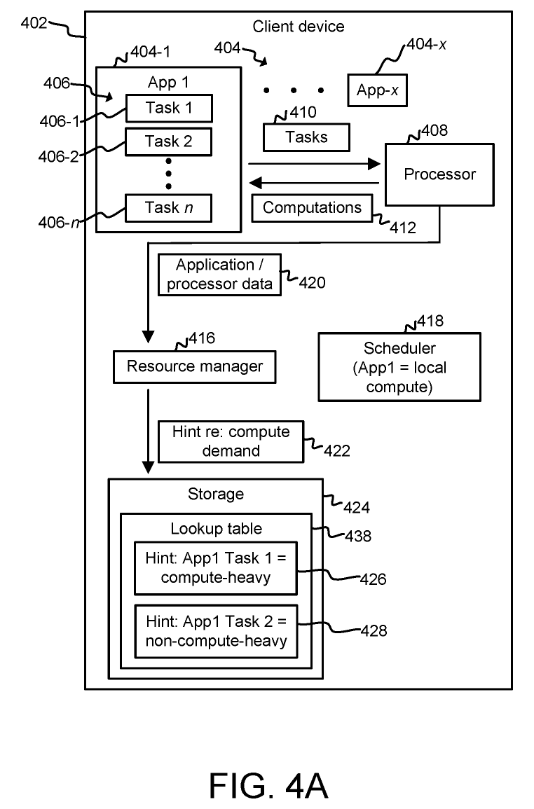

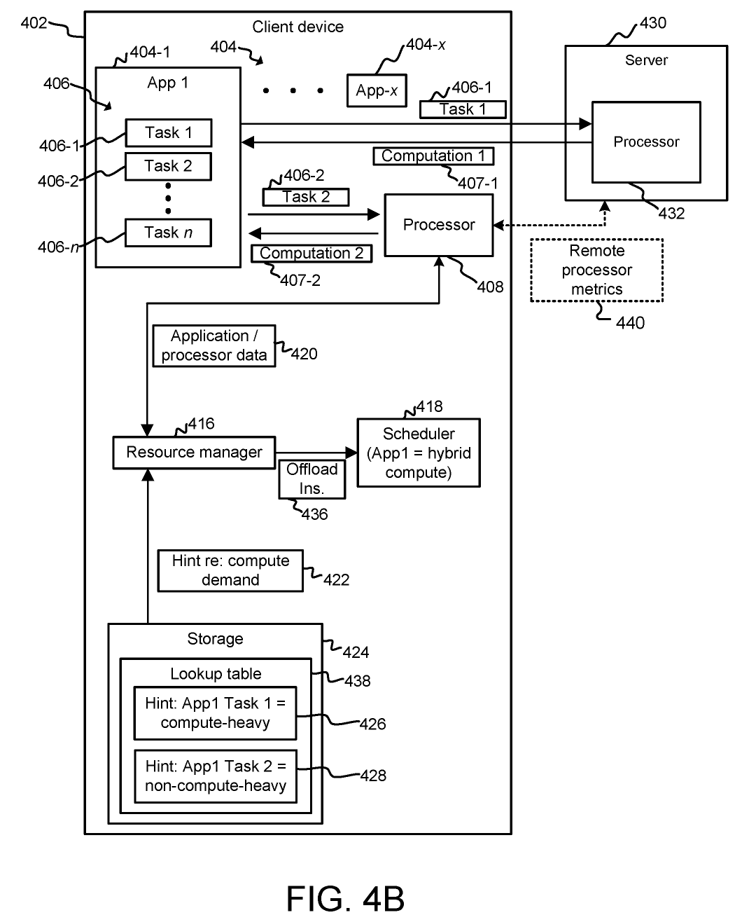

Following evaluate step 304, store operation 306 may store the task-based load or latency information based on the evaluation. The task-based load information may be stored in a storage location (e.g., memory of a server or client device). In this way, the task-based load information can be retrieved by the resource manager at a subsequent time for help in determining whether a task should be performed locally on a client device or offloaded to an alternate processor. In some instances, the resource manager can generate and store the task-based load information in the form of a lookup table, as discussed with respect to FIGS. 4A and 4B.

FIGS. 4A and 4B illustrate example applications of resource manager 416, in accordance with embodiments of the present disclosure. FIG. 4A illustrates a set of operations associated with client device 402 during the execution of an application, e.g., App 1 (404-1). FIG. 4B illustrates a set of operations associated with client device 402 that, in some instances, can occur following the execution operations depicted in FIG. 4A.

Turning to FIG. 4A, client device 402 includes a set of x applications 404, where x is an integer greater than zero. For example, x=1 in embodiments in which the set of applications 404 includes only a first application 404-1; x=2 in embodiments in which the set of applications 404 includes two applications (a first application 404-1 and a second application 404-2); and so on. Each application 404-x includes a set of tasks performed during execution of the application 404-x. For example, application 401-1 includes a set of n tasks 406, where n is an integer greater than zero as described above. In response to an instruction by the resource manager 416, each task 406-n can be performed by a local processor 408 of the client device 402 or by a remote processor 432 of a remote server 430, as discussed with respect to FIG. 4B. Computations 412 are results generated by local processor 408 corresponding to respective local tasks 410. In an example, local processor 408 can receive a local task 410 to perform a mathematical calculation, and after performing the calculation, local processor 408 can output the result of the mathematical calculation as computation 412.

As shown, some embodiments of client device 402 include the resource manager 416 and a scheduler 418. Resource manager 416 is configured to receive application data and/or processor data 420 and create, based on application data and/or processor data 420, a task-based load information or a hint 422 associated with a compute demand for a local task 410. Application data and/or processor data 420 can include information from local processor 408 and/or a set of performance counters associated with local processor 408. Such information can include a set of processing parameters (e.g., information about processor and/or memory usage, energy requirements, processing time, and the like) associated with performing local tasks 410 by local processor 408. Such processing parameters can indicate a computing demand for each local task 410 (e.g., a minimum processing capacity for performing a task within a threshold time). Hint 422 can include information generated by resource manager 416 that includes an analysis and/or characterization of application data and/or processor data 420. For example, hint 422 can include metadata indicating that application data and/or processor data 420 exceeds one or more thresholds. In another example, a hint 422 can include an alphanumeric character indicating that a task has a high computing demand and should be offloaded to a remote processor. In some instances, hint 422 can include application data and/or processor data 420. Resource manager 416 can store hint 422 in a storage location 424 of the client device 402 such that the hint 422 can be retrieved at a subsequent time and used to determine whether to process a task locally or remotely, as discussed with respect to FIG. 4B. In some instances, resource manager 416 can store hint 422 in a lookup table 438 associated with application 404-x. In some instances, resource manager 416 can communicate with scheduler 418 to control whether a task is performed by the local processor 408 or a remote processor.

In an example, as shown in FIG. 4B, execution of the application 404-1 can include performing a set of tasks 406 that includes a first task 406-1 (e.g., batch filtering) and a second task 406-2 (e.g., displaying a selection menu on a graphical user interface of client device 402). In this example, scheduler 418 assigns the set of tasks 406 of application 404-1 to local processor 408 for processing. Resource manager 416 can receive application data and/or processor data 420 from local processor 408. The application data and/or processor data 420 can include power performance states (e.g., frequency and/or voltage values) of local processor 408 corresponding to local processor 408 performing first task 406-1 and second task 406-2. Resource manager 416 can compare the application data and/or processor data 420 to predetermined frequency and/or voltage thresholds. Based on the comparison, the resource manager 416 can determine that the frequency and/or voltage values corresponding to the first task 406-1 exceed the threshold and that the frequency and/or voltage values corresponding to the second task 406-2 do not exceed the threshold. In response to those determinations, the resource manager 416 can generate and store a first hint 426 and a second hint 428. The first hint 426 can indicate that the first task 406-1 of the application 404-1 is a “compute-heavy” task. In this example, the “compute-heavy” label can indicate that the first task 406-1 may be processed more efficiently by a remote processor than by local processor 408. Continuing with this example, the second hint 428 and indicate that the second task 406-2 of the application 404-1 is a “non-compute-heavy” task. In this example, the “non-compute-heavy task” label can indicate that the second task 406-2 may be efficiently processed by local processor 408.

FIG. 4B illustrates resource manager 416 of client device 402 employing a hint to determine a processing location for a task. Particularly, FIG. 4B illustrates resource manager 416 initiating a transfer of first task 406-1 to remote processor 432 for processing based on first hint 426. Additionally, FIG. 4B illustrates resource manager 416 permitting second task 406-2 to be processed on local processor 408, based on second hint 428.

In response to application 404-1 being initiated on client device 402 (e.g., a user opens application 404-1 on client device 402), resource manager 416 can receive application data and/or processor data 420 indicating that application 404-1 is initiated. In some embodiments, resource manager 416 can receive application data and/or processor data 420 from local processor 408. In response to receiving the application data and/or processor data 420, the resource manager 416 can retrieve one or more hints 422 corresponding to application 404-1 from lookup table 438. The one or more hints 422 can indicate which tasks 406-n of application 404-1 can or should be processed by local processor 408 and which tasks 406-n of application 404-1 can or should be processed by remote processor 432 of remote server 430. Based on the one or more hints 422, resource manager 416 can generate a set of offload instructions 436 for scheduler 418. The set of offload instructions 436 can indicate which tasks 406-n of application 404-1 are to be transmitted to remote processor 432 for processing. In some instances, the set of offload instructions 436 can indicate which of the set of tasks 406 of application 404-1 are to be transmitted to remote processor 432 for processing and/or which of the set of tasks 406 of application 404-1 are to be processed by local processor 408.

Continuing with the example discussed with respect to FIG. 4A, in response to receiving an indication that application 404-1 is initiated, resource manager 416 can retrieve previously stored first hint 426, indicating that the first task 406-1 is a “compute-heavy” task, and previously stored second hint 428, indicating that the second task 406-2 is a “non-compute-heavy” task. Based on the first hint 426 and the second hint 428, the resource manager 416 can generate a set of offload instructions 436 for scheduler 418. The set of offload instructions 436 can indicate that the first task 406-1 is to be processed by remote processor 432 of remote server 430. The set of offload instructions 436 can further indicate that second task 406-2 is to be processed by local processor 408. In response to the set of offload instructions 436, scheduler 418 can be configured for hybrid processing, in which the scheduler 418 assigns some tasks of the set of tasks 406 to local processor 408 for processing and other tasks of the set of tasks 406 to remote processor 432 or processing. Accordingly, in this example, the scheduler 418 causes first task 406-1 and any data needed to process first task 406-1 to be transmitted to processor 432. In response, processor 432 outputs to client device 402 a first computation result 407-1 (e.g., a set of batch-filtered results) of the first task 406-1. Additionally in this example, the scheduler 418 causes second task 406-2 and any data needed to process second task 406-2 to be transmitted to local processor 408 for processing. In response, local processor 408 outputs a second computation result 407-2 (e.g., generating a selection menu for a graphical user interface of client device 402) of the second task 406-2. The first computation result 407-1 and the second computation result 407-2 can be utilized by application 404-1.

In embodiments, prior to transmitting the first task 406-1 to processor 432, processor 408 may request and receive metrics 440 related to the state of the remote processor 432. For instance, in embodiments, the processor 408 may evaluate the current processing burden of the remote processor to further consider whether transmitting the first task 406-1 to remote processor 432 will cause excessive latency. Such remote processor metrics 440 may be evaluated against, for example, latency threshold values stored in storage 424. The threshold values may be provided by the application 404-1 and/or by the task itself.

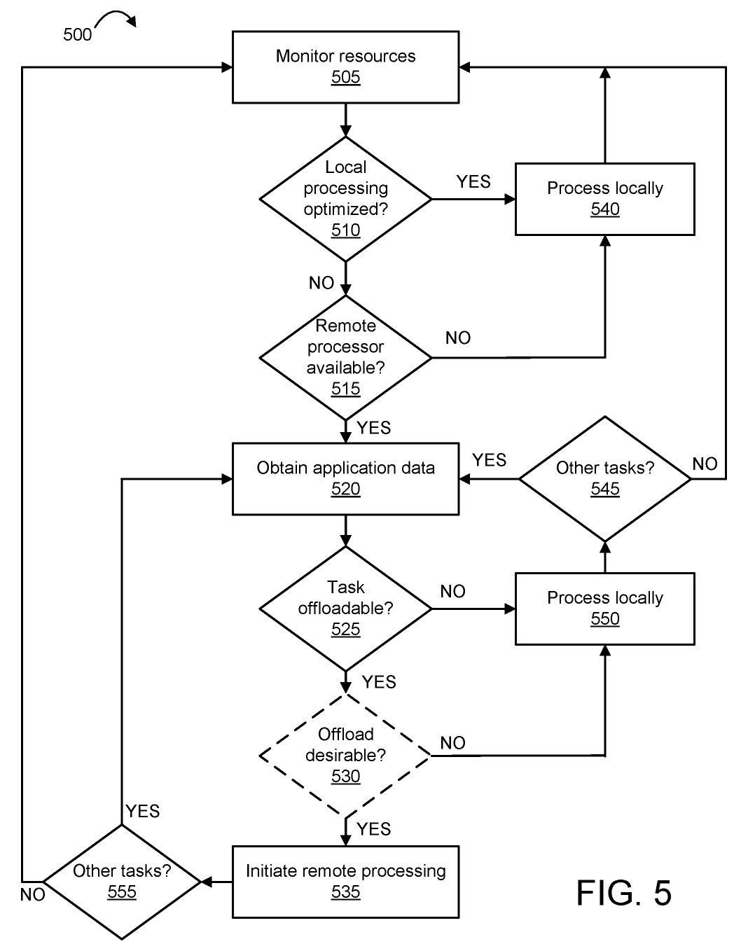

FIG. 5 shows a flowchart of an example method 500 for managing compute resources, in accordance with some embodiments of the present disclosure. In some instances, method 500 can be performed by a resource manager 116, FIG. 1, and will be described herein as such. Those skilled in the art will appreciate that other modules or components may perform many or all of these operations.

Method 500 generally begins with monitor operation 505 wherein the resource manager monitors one or more processors to obtain processor data (e.g., information associated with a processor’s availability, compute/processing capacity, and/or processing performance). In an example, the resource manager can obtain a percentage utilization value of a processor of the client device. In this example, the processor can be performing a set of tasks for a set of applications. The percentage utilization value can indicate the compute demand on the processor by the set of tasks (e.g., a higher percentage utilization value can indicate that one or more tasks may be compute-heavy).

In operation 510, the resource manager determines, based on the processor data, whether task performance by one or more processors of the client device is optimized. For example, in some instances, operation 510 includes the resource manager determining whether the one or more processors operate with a preferred degree of efficiency and/or responsiveness. Operation 510 can include considerations substantially similar to those discussed with respect to operation 206, FIG. 2. For example, the resource manager can identify a processing inefficiency in response to determining that while performing one or more tasks, a processor has a processing time duration, voltage, frequency, and/or percent utilization that approaches or exceeds a threshold. In response to determining that processing is optimized, the resource manager proceeds to operation 540. In response to determining that processing is not optimized (e.g., identifying a processing inefficiency), the resource manager proceeds to operation 515.

In operation 515, in some embodiments the resource manager determines, whether a remote processor is available for performing a task. In an example, the resource manager can obtain information indicating that a remote processor is presently accessible by a network and has available processing capacity. In this example, if the resource manager can determine that the remote processor is available for performing a task, flow branches YES to operation 520. In response to determining that a remote processor is not available for performing a task, flow branches NO to operation 540.

In operation 540, the resource manager processes one or more tasks by one or more processors locally, e.g., on the client device.

In operation 520, the resource manager obtains task-based load information, such as a stored hint related to the executing and/or queued for potential execution to determine if one or more tasks can or should be offloaded. In an example, a processor of the client device can be performing two tasks of a first application and three tasks of a second application. In this example, the resource manager can obtain application data that includes hints for each of the five tasks. Each hint can indicate information such as whether the respective task is a user-interactive task and/or whether the respective task is compute-heavy.

In operation 525, the resource manager determines, based on the task-based load information, and/or other processor information to dynamically determine whether a task is offloadable (e.g., whether a task can effectively be performed by a remote processor). The offloadability of a task can be determined according to criteria selected by an entity such as a programmer or a user of the resource manager. In an example, user-interactive tasks can be deemed non-offloadable. In another example, low latency tasks may be deemed not offloadable. In yet another example, a task may be deemed not offloadalble if the offloading of such a task may result in excessive latency due to a feedback analysis from the remote processor. Accordingly, in response to receiving a hint that a task is a user-interactive task, the resource manager can determine that the task is not offloadable and proceed to operation 550 to process the tasks locally.

On the other hand, in response to determining that a task is offloadable, the resource manager proceeds to operation 535. In situations, a task may be deemed offloadable despite the stored task-based load information, e.g., when the processor performance and/or efficiency would significantly decrease, a task may be selected for offloading. The selection process is dynamic in that the selection is based on current information related to the processor and/or the task itself.

Some embodiments of the present disclosure include operation 530. In operation 530, the resource manager determines, based on application data and/or processor data, whether offloading a task is desirable. In an example, operation 530 can include ranking a set of tasks in descending order according to compute demand. In this example, a highest-ranking task can be deemed desirable to offload based on having the highest compute demand among the set of tasks. Similarly, a lowest-ranking task can be deemed not desirable to offload based on having the lowest compute demand among the set of tasks. In response to determining that a task is desirable to offload, the resource manager proceeds to operation 535. In response to determining that a task is not desirable to offload, the resource manager proceeds to operation 550.

In operation 535, the resource manager can initiate a transfer of the task to a remote processor of a remote server. Operation 535 can be identical or substantially similar to operation 214, FIG. 2.

In operation 545 and in operation 555, the resource manager determines whether an additional task is to be analyzed for determining a respective processing location. Continuing with the example discussed with respect to operation 520, the resource manager can determine that a first task of the set of five tasks is to be processed by a local processor of the client device. In response to identifying that there are four additional tasks to be processed, the resource manager can analyze, by operation 525, and in some embodiments, by operation 530, a second task of the set of five tasks. In this example, the resource manager can proceed to operation 520 and analyze each task until each of the five tasks is analyzed. In response to determining that no additional tasks remain to be analyzed, the resource manager can proceed to operation 505.

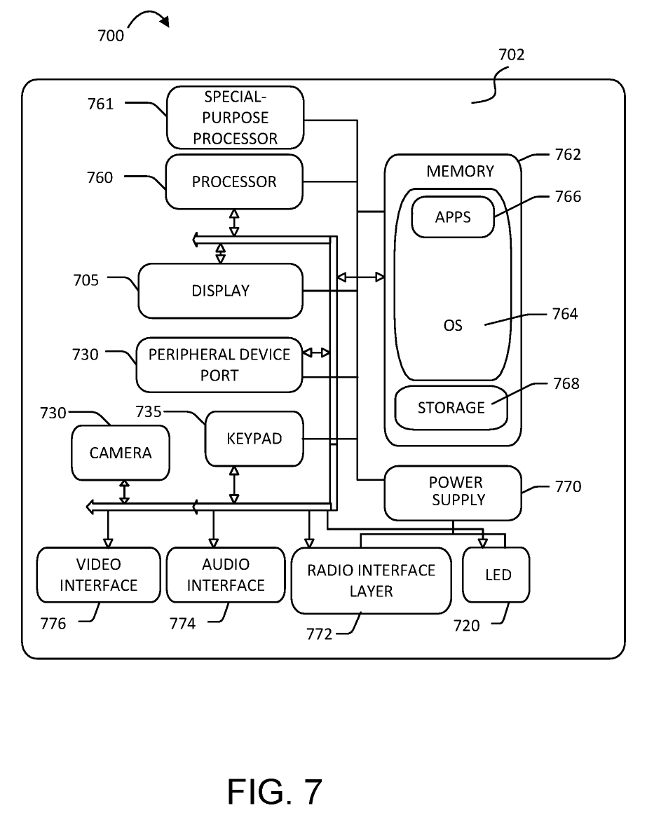

FIGS. 6-7 and the associated descriptions provide a discussion of a variety of operating environments in which aspects of the disclosure may be practiced. However, the devices and systems illustrated and discussed with respect to FIGS. 6-7 are for purposes of example and illustration and are not limiting of a vast number of computing device configurations that may be utilized for practicing aspects of the disclosure, described herein.

FIG. 6 is a block diagram illustrating physical components (e.g., hardware) of a computing device 600 with which aspects of the disclosure may be practiced. The computing device components described below may be suitable for the computing devices described above, including client device 120 in FIG. 1. In a basic configuration, the computing device 600 may include at least one processing unit 602 and a system memory 604. Depending on the configuration and type of computing device, the system memory 604 may comprise, but is not limited to, volatile storage (e.g., random access memory), non-volatile storage (e.g., read-only memory), flash memory, or any combination of such memories.

The system memory 604 may include an operating system 605 and one or more program modules 606 suitable for running software application 620, such as one or more components supported by the systems described herein. The operating system 605, for example, may be suitable for controlling the operation of the computing device 600.

Furthermore, aspects of the disclosure may be practiced in conjunction with a graphics library, other operating systems, or any other application program and is not limited to any particular application or system. This basic configuration is illustrated in FIG. 6 by those components within a dashed line 608. The computing device 600 may have additional features or functionality. For example, the computing device 600 may also include additional data storage devices (removable and/or non-removable) such as, for example, magnetic disks, optical disks, or solid state storage devices. Such additional storage is illustrated in FIG. 6 by a removable storage device 609 and a non-removable storage device 610.

As stated above, a number of program modules and data files may be stored in the system memory 604. While executing on the processing unit 602, the program modules 606 (e.g., application 620) may perform processes including, but not limited to, the aspects, as described herein. Other program modules that may be used in accordance with aspects of the present disclosure may include electronic mail and contacts applications, word processing applications, spreadsheet applications, database applications, slide presentation applications, drawing or computer-aided application programs, etc.

Furthermore, aspects of the disclosure may be practiced in an electrical circuit comprising discrete electronic elements, packaged or integrated electronic chips containing logic gates, a circuit utilizing a microprocessor, or on a single chip containing electronic elements or microprocessors. For example, aspects of the disclosure may be practiced via a system-on-a-chip (SOC) where each or many of the components illustrated in FIG. 6 may be integrated onto a single integrated circuit. Such an SOC device may include one or more processing units, graphics units, communications units, system virtualization units and various application functionality all of which are integrated (or “burned”) onto the chip substrate as a single integrated circuit. When operating via an SOC, the functionality, described herein, with respect to the capability of client to switch protocols may be operated via application-specific logic integrated with other components of the computing device 600 on the single integrated circuit (chip). Some aspects of the disclosure may also be practiced using other technologies capable of performing logical operations such as, for example, AND, OR, and NOT, including but not limited to mechanical, optical, fluidic, and quantum technologies. In addition, some aspects of the disclosure may be practiced within a general purpose computer or in any other circuits or systems.

The computing device 600 may also have one or more input device(s) 612 such as a keyboard, a mouse, a pen, a sound or voice input device, a touch or swipe input device, etc. The output device(s) 614 such as a display, speakers, a printer, etc. may also be included. The aforementioned devices are examples and others may be used. The computing device 600 may include one or more communication connections 616 allowing communications with other computing devices 650. Examples of suitable communication connections 616 include, but are not limited to, wired connections such as through ethernet cabling, radio frequency (RF) transmitter, receiver, and/or transceiver circuitry; universal serial bus (USB), parallel, and/or serial ports, among others.

The term computer readable media as used herein may include computer storage media. Computer storage media may include volatile and nonvolatile, removable and non-removable media implemented in any method or technology for storage of information, such as computer readable instructions, data structures, or program modules. The system memory 604, the removable storage device 609, and the non-removable storage device 610 are all computer storage media examples (e.g., memory storage). Computer storage media may include RAM, ROM, electrically erasable read-only memory (EEPROM), flash memory or other memory technology, CD-ROM, digital versatile disks (DVD) or other optical storage, magnetic cassettes, magnetic tape, magnetic disk storage or other magnetic storage devices, or any other article of manufacture which can be used to store information and which can be accessed by the computing device 600. Any such computer storage media may be part of the computing device 600. Computer storage media does not include a carrier wave or other propagated or modulated data signal.

Communication media may be embodied by computer readable instructions, data structures, program modules, or other data in a modulated data signal, such as a carrier wave or other transport mechanism, and includes any information delivery media. The term “modulated data signal” may describe a signal that has one or more characteristics set or changed in such a manner as to encode information in the signal. By way of example, and not limitation, communication media may include wired media such as a wired network or direct-wired connection, and wireless media such as acoustic, radio frequency (RF), infrared, and other wireless media.

FIG. 7 illustrates a mobile computing device 700, for example, a mobile telephone, a smart phone, wearable computer (such as a smart watch), a tablet computer, a laptop computer, and the like, with which some aspects of the disclosure may be practiced. In some aspects, the client may be a mobile computing device, but in other aspects, the client may be a workstation or otherwise not considered a mobile device. Hence, the mobile computing device 700 is provided as an exemplary computing device that may be used as a client in relation to aspects discussed herein.

FIG. 7 is a block diagram illustrating the architecture of one aspect of a mobile computing device. That is, the mobile computing device 700 can incorporate a system (e.g., an architecture) 702 to implement some aspects. In some examples, the system 702 is implemented as a “smart phone” capable of running one or more applications (e.g., browser, e-mail, calendaring, contact managers, messaging clients, games, and media clients/players). In some aspects, the system 702 is integrated as a computing device, such as an integrated personal digital assistant (PDA) and wireless phone.

One or more application programs 766 may be loaded into the memory 762 and run on or in association with the operating system 764. Examples of the application programs include phone dialer programs, e-mail programs, personal information management (PIM) programs, word processing programs, spreadsheet programs, Internet browser programs, messaging programs, and so forth. The system 702 also includes a non-volatile storage area 768 within the memory 762. The non-volatile storage area 768 may be used to store persistent information that should not be lost if the system 702 is powered down. The application programs 766 may use and store information in the non-volatile storage area 768, such as e-mail or other messages used by an e-mail application, and the like. A synchronization application (not shown) also resides on the system 702 and is programmed to interact with a corresponding synchronization application resident on a host computer to keep the information stored in the non-volatile storage area 768 synchronized with corresponding information stored at the host computer. As should be appreciated, other applications may be loaded into the memory 762 and run on the mobile computing device 700 described herein.

The system 702 has a power supply 770, which may be implemented as one or more batteries. The power supply 770 might further include an external power source, such as an AC adapter or a powered docking cradle that supplements or recharges the batteries.

The system 702 may also include a radio interface layer 772 that performs the function of transmitting and receiving radio frequency communications. The radio interface layer 772 facilitates wireless connectivity between the system 702 and the “outside world,” via a communications carrier or service provider. Transmissions to and from the radio interface layer 772 are conducted under control of the operating system 764. In other words, communications received by the radio interface layer 772 may be disseminated to the application programs 766 via the operating system 764, and vice versa.

The visual indicator 720 may be used to provide visual notifications, and/or an audio interface 774 may be used for producing audible notifications. In the illustrated example, the visual indicator 720 is a light emitting diode (LED) and the audio interface 774 is a speaker. These devices may be directly coupled to the power supply 770 so that when activated, they remain on for a duration dictated by the notification mechanism even though the processor 760 and/or special-purpose processor 761 and other components might shut down for conserving battery power. The LED may be programmed to remain on indefinitely until the user takes action to indicate the powered-on status of the device. The audio interface 774 is used to provide audible signals to and receive audible signals from the user. For example, in addition to being coupled to the audio transducer 725, the audio interface 774 may also be coupled to a microphone to receive audible input, such as to facilitate a telephone conversation. In accordance with aspects of the present disclosure, the microphone may also serve as an audio sensor to facilitate control of notifications, as will be described below. The system 702 may further include a video interface 776 that enables an operation of an on-board camera 730 to record still images, video stream, and the like.

A mobile computing device 700 implementing the system 702 may have additional features or functionality. For example, the mobile computing device 700 may also include additional data storage devices (removable and/or non-removable) such as, magnetic disks, optical disks, or tape. Such additional storage is illustrated in FIG. 7 by the non-volatile storage area 768.

Data/information generated or captured by the mobile computing device 700 and stored via the system 702 may be stored locally on the mobile computing device 700, as described above, or the data may be stored on any number of storage media that may be accessed by the device via the radio interface layer 772 or via a wired connection between the mobile computing device 700 and a separate computing device associated with the mobile computing device 700, for example, a server computer in a distributed computing network, such as the Internet. As should be appreciated such data/information may be accessed via the mobile computing device 700 via the radio interface layer 772 or via a distributed computing network. Similarly, such data/information may be readily transferred between computing devices for storage and use according to well-known data/information transfer and storage means, including electronic mail and collaborative data/information sharing systems.

As will be understood from the foregoing disclosure, one aspect of the technology relates to a method for improving application processing efficiency. The method includes performing a plurality of tasks on a client device. The method further includes evaluating processor data associated with performing the plurality of tasks. The method further includes determining, based on the processor data, a processing inefficiency. In response to determining the processing inefficiency, the method includes evaluating the plurality of tasks and selecting at least one target task for offloading. The method further includes offloading the target task to an alternate device for performing the target task on the alternate device and receiving results from the alternate device upon completion of the target task. In further aspects, the alternate device comprises a remote processor of a remote server.

In further aspects, the method includes generating the stored task-based load information, wherein the generation involves: performing the plurality of tasks on the client device; obtaining initial processor data associated with performing the plurality of tasks; generating the information based on the initial processor data; and storing the same. In further aspects, the stored task-based load information may include an indication that the target task is a compute-heavy task. In further aspects, the stored task-based load information may be included in a lookup table associated with an application of the client device. In further aspects, the evaluating the plurality of tasks includes ranking the plurality of tasks according to compute demand. In further aspects, the stored task-based load information may include an indication that the target task is not a user-interactive task and/or not latency sensitive.

In further aspects, embodiments described herein relate to a system having at least one processor; and memory storing instructions that, when executed by the at least one processor, cause the system to perform a set of operations. The set of operations relate to performing a plurality of tasks on a client device; evaluating processor data associated with performing the plurality of tasks; determining, based on the processor data, a processing inefficiency; in response to determining the processing inefficiency, evaluating the plurality of tasks; dynamically selecting a target task that may be offloaded; and offloading the target task to an alternate device for performing the target task on the alternate device.

The description and illustrations of one or more aspects provided in this application are not intended to limit or restrict the scope of the disclosure as claimed in any way. The aspects, examples, and details provided in this application are considered sufficient to convey possession and enable others to make and use claimed aspects of the disclosure. The claimed disclosure should not be construed as being limited to any aspect, example, or detail provided in this application. Regardless of whether shown and described in combination or separately, the various features (both structural and methodological) are intended to be selectively included or omitted to produce an embodiment with a particular set of features. Having been provided with the description and illustration of the present application, one skilled in the art may envision variations, modifications, and alternate aspects falling within the spirit of the broader aspects of the general inventive concept embodied in this application that do not depart from the broader scope of the claimed disclosure.

We claim:

1. A method for improving application processing efficiency, the method comprising:
performing a plurality of applications on a client device, wherein each of the plurality of applications has a plurality of tasks to execute to complete the application processing;
evaluating processor data associated with performing one more of the plurality of tasks;
determining, based on the processor data, a processing inefficiency;
in response to determining the processing inefficiency, evaluating one or more of the plurality of tasks;
dynamically selecting, at least one target task to be offloaded;
offloading the target task to an alternate device for performing the target task on the alternate device; and
receiving results from the alternate device.

2. The method of claim 1 wherein:
the dynamic selection is partially based on task-based load information.

3. The method of claim 2 wherein the task-based load information
is generated by:
performing the plurality of tasks on the client device;
obtaining initial processor data associated with performing the plurality of tasks;
generating task-based load information based on the initial processor data; and
storing the task-based load information.

4. The method of claim 2, wherein the task-based load information includes an indication that the target task is a compute-heavy task.

5. The method of claim 2, wherein the task-based load information includes an indication that the target task is not one or more of the following: a user-interactive task or a latency sensitive task.

6. The method of claim 2, wherein the evaluating the plurality of tasks includes ranking the plurality of tasks according to compute demand.

7. The method of claim 2, further comprising:
receiving feedback from the alternate device regarding state information; and
prior to offloading the target task, determining the offloading will not exceed a predetermined latency threshold.

8. A system comprising:
at least one processor; and
memory storing instructions that, when executed by the at least one processor, cause the system to perform a set of operations comprising:
performing a plurality of tasks on a client device;
evaluating processor data associated with performing the plurality of tasks;
determining, based on the processor data, a processing inefficiency;
in response to determining the processing inefficiency, evaluating the plurality of tasks;
dynamically selecting a target task that may be offloaded; and
offloading the target task to an alternate device for performing the target task on the alternate device.

9. The system of claim 8, the set of operations further comprising:
generating task-based load information by:
performing the plurality of tasks on the client device;
obtaining initial processor data associated with performing the plurality of tasks;
generating task-based load information based on the initial processor data; and
storing the task-based load information; and
using the task-based load information to dynamically select the target task for offloading.

10. The system of claim 8, wherein the alternate device comprises a remote processor of a remote server.

11. The system of claim 9, wherein the task-based load information has an indication that the target task is a compute-heavy task.

12. The system of claim 9, wherein the task-based load information includes an indication that the target task is not one or more of the following: a user-interactive task or a latency sensitive task.

13. The system of claim 8, wherein the evaluating the plurality of tasks includes ranking the plurality of tasks according to compute demand.

14. The system of claim 8, wherein the set of operations further comprises:
receiving feedback from the alternate device regarding state information; and
prior to offloading the target task, determining the offloading will not exceed a predetermined latency threshold.

15. A computer program product comprising one or more computer readable storage media, and program instructions collectively stored on the one or more computer readable storage media, the program instructions comprising instructions configured to cause one or more processors to perform a method for improving task completion efficiency, the method comprising:
performing a plurality of tasks on a client device;
evaluating processor data associated with performing the plurality of tasks;
determining, based on the processor data, a processing inefficiency;
in response to determining the processing inefficiency, evaluating the plurality of tasks;
selecting, based on stored hints associated with the plurality of tasks, a target task that may be offloaded; and
offloading the target task to an alternate device for performing the target task on the alternate device.

16. The computer program product of claim 15, the method further comprising:
generating the stored hints by:
performing the plurality of tasks on the client device;
obtaining initial processor data associated with performing the plurality of tasks;
generating hints based on the initial processor data; and
storing the hints, resulting in the stored hints.

17. The computer program product of claim 15, wherein the alternate device comprises a remote processor of a remote server.

18. The computer program product of claim 15, wherein the stored hints include an indication that the target task is one or more of the following: a compute-heavy task, a non-user-interface task, and not latency sensitive.

19. The computer program product of claim 15, the method further comprising:
receiving feedback from the alternate device regarding state information; and
prior to offloading the target task, determining the offloading will not exceed a predetermined latency threshold.

20. The computer program product of claim 15, wherein the evaluating the plurality of tasks includes ranking the plurality of tasks according to compute demand.
